(19) United States
(12) Patent Application Publication
(10) Pub. No.: US 2026/0134367 A1
(43) Pub. Date: May 14, 2026

(54) INFORMATION PROCESSING DEVICE, COMMUNICATION SYSTEM, AND CONTROL METHOD

(71) Applicant: Mitsubishi Electric Corporation, Tokyo (JP)

(72) Inventor: Shingo MINE, Tokyo (JP)

(73) Assignee: Mitsubishi Electric Corporation, Tokyo (JP)

(21) Appl. No.: 19/442,686

(22) Filed: Jan. 7, 2026

Related U.S. Application Data
(63) Continuation of application No. PCT/JP2023/034257, filed on Sep. 21, 2023.

(51) Int. Cl. G06Q 10/0631; G06F 40/268

(52) U.S. Cl. CPC G06Q 10/06316; G06F 40/268

(57) ABSTRACT

An information processing device includes a communication unit that receives work instruction information as information indicating a work instruction to a worker, a morphological analysis performing unit that performs morphological analysis on the work instruction information, a determination unit that determines a work type based on result of the morphological analysis, an acquisition unit that acquires a management table as information for generating tasks corresponding to the work instruction or manual data of the work, and a generation unit that generates the tasks based on the management table or the manual data, the work type, and one or more words obtained by the morphological analysis. The communication unit transmits the tasks to a terminal device when the tasks are generated.

### CROSS-REFERENCE TO RELATED APPLICATION

This application is a continuation application of International Application No. PCT/JP2023/034257 having an international filing date of Sep. 21, 2023, all of which is hereby expressly incorporated by reference into the present application.

### BACKGROUND OF THE INVENTION

### 1. Field of the Invention

The present disclosure relates to an information processing device, a communication system, and a control method.

### 2. Description of the Related Art

A lot of workers work in a factory, a warehouse or the like. Here, a remote work support system that enables each worker to acquire a work plan has been proposed (see Patent Reference 1).

Patent Reference 1: Japanese Patent No. 6157774

Additionally, there are cases where a work instructor issues a work instruction by using a device. The work instruction is received by a terminal device of a worker. When the contents of the work instruction are insufficient information, the worker makes an inquiry to the work instructor. When the work instructor replies to the inquiry, the load on the work instructor is heavy.

### SUMMARY OF THE INVENTION

The object of the present disclosure is to reduce the load on the work instructor.

An information processing device according to an aspect of the present disclosure is provided. The information processing device communicates with a terminal device used by a worker. The information processing device includes a communication unit that receives work instruction information as information indicating a work instruction to the worker, a morphological analysis performing unit that performs morphological analysis on the work instruction information, a determination unit that determines a work type based on result of the morphological analysis, an acquisition unit that acquires management information as information for generating tasks corresponding to the work instruction or manual data of the work, and a generation unit that generates the tasks based on the management information or the manual data, the work type, and one or more words obtained by the morphological analysis. The communication unit transmits the tasks to the terminal device when the tasks are generated.

According to the present disclosure, the load on the work instructor can be reduced.

### BRIEF DESCRIPTION OF THE DRAWINGS

The present disclosure will become more fully understood from the detailed description given hereinbelow and the accompanying drawings which are given by way of illustration only, and thus are not limitative of the present disclosure, and wherein:

FIG. 1 is a diagram showing a communication system in a first embodiment;

FIG. 2 is a diagram showing hardware included in an information processing device in the first embodiment;

FIG. 3 is a block diagram showing functions of the information processing device in the first embodiment;

FIG. 4 is a diagram showing an example of a management table in the first embodiment;

FIG. 5 is a flowchart showing an example of a process executed by the information processing device in the first embodiment;

FIG. 6 is a diagram showing an example (No. 1) of the management table in a first modification of the first embodiment;

FIG. 7 is a diagram showing an example (No. 2) of the management table in the first modification of the first embodiment;

FIG. 8 is a diagram showing an example of a work management table in the first modification of the first embodiment;

FIG. 9 is a diagram showing an example of a conveyance management table in the first modification of the first embodiment;

FIG. 10 is a diagram showing an example of the management table in a third modification of the first embodiment;

FIG. 11 is an image diagram of a communication system in the third modification of the first embodiment;

FIG. 12 is a diagram showing a communication system in a second embodiment;

FIG. 13 is a block diagram showing functions of an information processing device in the second embodiment; and

FIG. 14 is a flowchart showing an example of a process executed by the information processing device in the second embodiment.

### DETAILED DESCRIPTION OF THE INVENTION

Embodiments will be described below with reference to the drawings. The following embodiments are just examples and a variety of modifications are possible within the scope of the present disclosure.

### First Embodiment

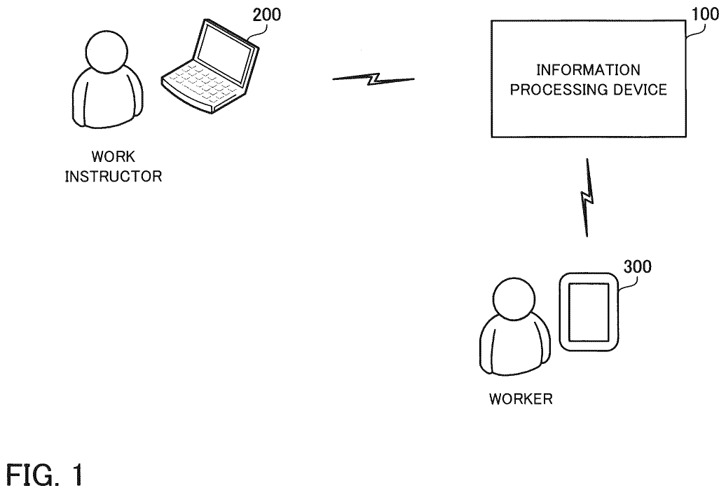

FIG. 1 is a diagram showing a communication system in a first embodiment. The communication system includes an information processing device 100 and a terminal device 300. The communication system may include an information processing device 200.

The information processing device 100, the information processing device 200 and the terminal device 300 execute communication via a network. The network is a wired network or a wireless network.

The information processing device 100 is a device that executes a control method. The information processing device 100 is a server, for example.

The information processing device 200 is a device used by a work instructor. The information processing device 200 is a Personal Computer (PC), for example. Further, the work instructor is a person at a managerial position, a knowledgeable person or the like, for example. For example, the work instructor exists in an office.

The terminal device 300 is a device used by a worker. The terminal device 300 is a smartphone, a tablet device or the like, for example. Further, the worker is a new employee, a gig worker or the like, for example. For example, the worker exists in a warehouse.

Next, hardware included in the information processing device 100 will be described below.

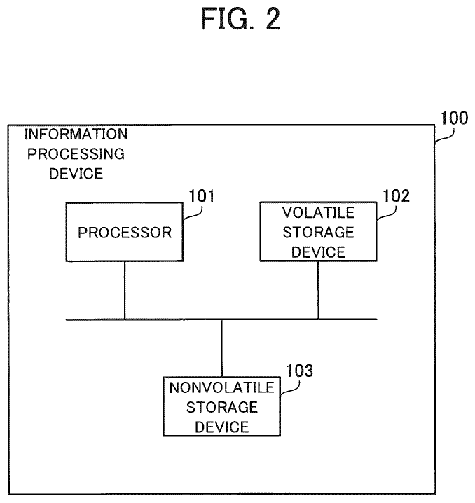

FIG. 2 is a diagram showing the hardware included in the information processing device in the first embodiment. The information processing device 100 is a computer. The information processing device 100 includes a processor 101, a volatile storage device 102 and a nonvolatile storage device 103.

The processor 101 controls the whole of the information processing device 100. The processor 101 is a Central Processing Unit (CPU), a Field Programmable Gate Array (FPGA) or the like, for example. The processor 101 can also be a multiprocessor. Further, the information processing device 100 may include processing circuitry.

The volatile storage device 102 is main storage of the information processing device 100. The volatile storage device 102 is a Random Access Memory (RAM), for example. The nonvolatile storage device 103 is auxiliary storage of the information processing device 100. The nonvolatile storage device 103 is a Hard Disk Drive (HDD) or a Solid State Drive (SSD), for example.

Further, each of the information processing device 200 and the terminal device 300 includes a processor, a volatile storage device and a nonvolatile storage device similarly to the information processing device 100.

Next, functions of the information processing device 100 will be described below.

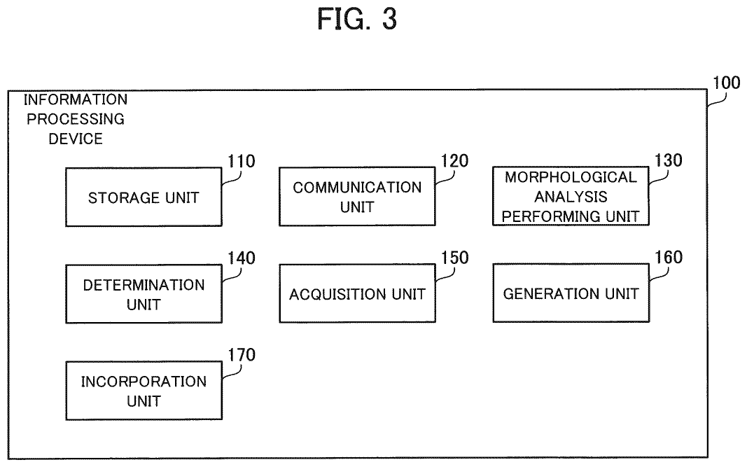

FIG. 3 is a block diagram showing the functions of the information processing device in the first embodiment. The information processing device 100 includes a storage unit 110, a communication unit 120, a morphological analysis performing unit 130, a determination unit 140, an acquisition unit 150, a generation unit 160 and an incorporation unit 170.

The storage unit 110 may be implemented as a storage area reserved in the volatile storage device 102 or the nonvolatile storage device 103.

Part or all of the communication unit 120, the morphological analysis performing unit 130, the determination unit 140, the acquisition unit 150, the generation unit 160 and the incorporation unit 170 may be implemented by processing circuitry. Further, part or all of the communication unit 120, the morphological analysis performing unit 130, the determination unit 140, the acquisition unit 150, the generation unit 160 and the incorporation unit 170 may be implemented as modules of a program executed by the processor 101. For example, the program executed by the processor 101 is referred to also as a control program. The control program has been recorded in a record medium, for example.

The storage unit 110 stores a variety of information.

The communication unit 120 receives work instruction information. For example, the communication unit 120 receives the work instruction information from the information processing device 200. The work instruction information is information indicating a work instruction to the worker. In the following description, the work instruction is assumed to be “Convey an article X.”.

The morphological analysis performing unit 130 performs morphological analysis on the work instruction information.

The determination unit 140 determines a type of the work (namely, a work type) based on the result of the morphological analysis. For example, the determination unit 140 determines the work type “conveyance” based on “convey”.

The acquisition unit 150 acquires a management table. For example, the acquisition unit 150 acquires the management table from the storage unit 110. Further, for example, the acquisition unit 150 acquires the management table from an external device. Incidentally, the external device is a device existing outside the information processing device 100. The external device is a cloud server, for example. Illustration of the external device is left out. Here, an example of the management table will be shown below.

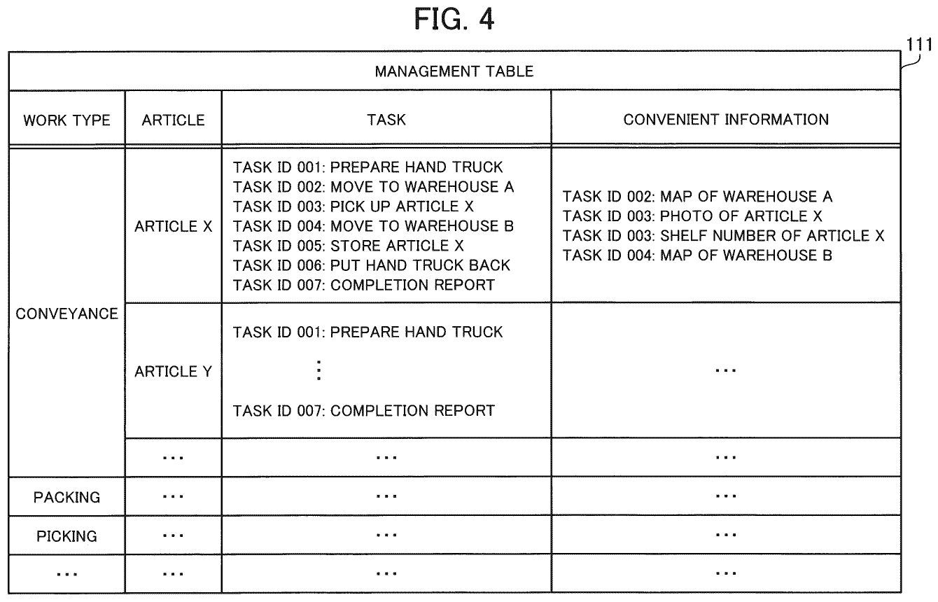

FIG. 4 is a diagram showing an example of the management table in the first embodiment. For example, the management table 111 has been stored in the storage unit 110. The management table 111 is referred to also as management information. The management table 111 is information for generating tasks corresponding to the work instruction.

For example, the management table 111 includes items of work type, article, task and convenient information. Incidentally, the convenient information is information that is convenient for executing each task.

The generation unit 160 generates tasks based on the management table 111, the work type, and one or more words obtained by the morphological analysis. In other words, the generation unit 160 generates tasks for implementing the work corresponding to the work instruction. A concrete example will be described below. The work type is assumed to be “conveyance”. The one or more words obtained by the morphological analysis are assumed to be “article X”. The generation unit 160 identifies tasks corresponding to “conveyance” and “article X” based on the management table 111. The generation unit 160 generates tasks based on the identified tasks.

Further, the generation unit 160 may generate the convenient information corresponding to the tasks. For example, the generation unit 160 generates the convenient information corresponding to the identified tasks based on the management table 111. Furthermore, the convenient information may be stored in the external device. In the case where the convenient information is stored in the external device, the acquisition unit 150 may acquire the convenient information corresponding to the tasks by accessing to the external device.

The communication unit 120 transmits the tasks and the convenient information to the terminal device 300.

Next, a process executed by the information processing device 100 will be described below by using a flowchart.

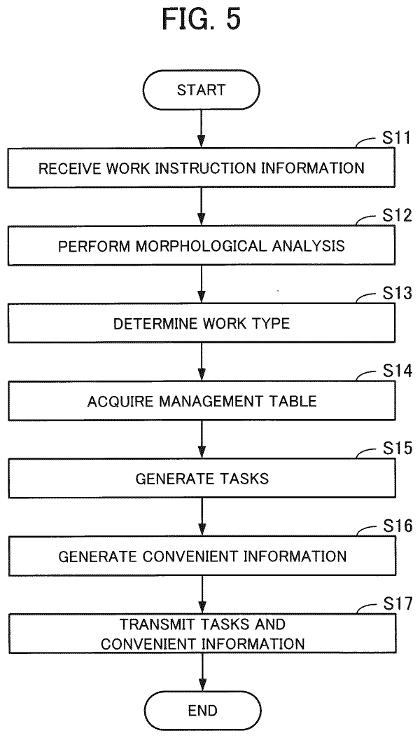

FIG. 5 is a flowchart showing an example of the process executed by the information processing device in the first embodiment.

(Step S11) The communication unit 120 receives the work instruction information from the information processing device 200.

(Step S12) The morphological analysis performing unit 130 performs the morphological analysis on the work instruction information.

(Step S13) The determination unit 140 determines the work type based on the result of the morphological analysis.

(Step S14) The acquisition unit 150 acquires the management table 111.

(Step S15) The generation unit 160 generates tasks based on the management table 111, the work type, and one or more words obtained by the morphological analysis.

(Step S16) The generation unit 160 generates the convenient information corresponding to the tasks by using the management table 111.

(Step S17) The communication unit 120 transmits the tasks and the convenient information to the terminal device 300.

Incidentally, there are cases where the contents of the work instruction are insufficient information. For example, when the work instruction is “Convey an article X.”, there are cases where the worker does not know the place where the article X is, first. Further, when the work instruction is “Convey an article X.”, there are cases where the worker does not know where the article X should be conveyed to. When the contents of the work instruction are insufficient information as above, the worker makes an inquiry to the work instructor. When the work instructor replies to the inquiry, the load on the work instructor is heavy.

According to the first embodiment, the information processing device 100 generates tasks for implementing the work corresponding to the work instruction. In short, the information processing device 100 generates tasks for the worker to execute the work by supplementing the contents of the work instruction with information. The information processing device 100 transmits the tasks to the terminal device 300. This enables the worker to execute the work without making an inquiry to the work instructor. Accordingly, the information processing device 100 is capable of reducing the load on the work instructor.

Further, the information processing device 100 transmits the convenient information to the terminal device 300. By acquiring the convenient information, the worker can execute the work more smoothly.

Here, the worker may transmit a question to the information processing device 100 by using the terminal device 300. When a question is received from the terminal device 300, the communication unit 120 transmits a reply to the question to the terminal device 300. The incorporation unit 170 incorporates the reply to the question into the management table 111. Accordingly, the management table 111 is updated to fulfilling contents.

### First Modification of First Embodiment

An example of the management table 111 has been shown in FIG. 4. The management table 111 can also be a table like the one shown below.

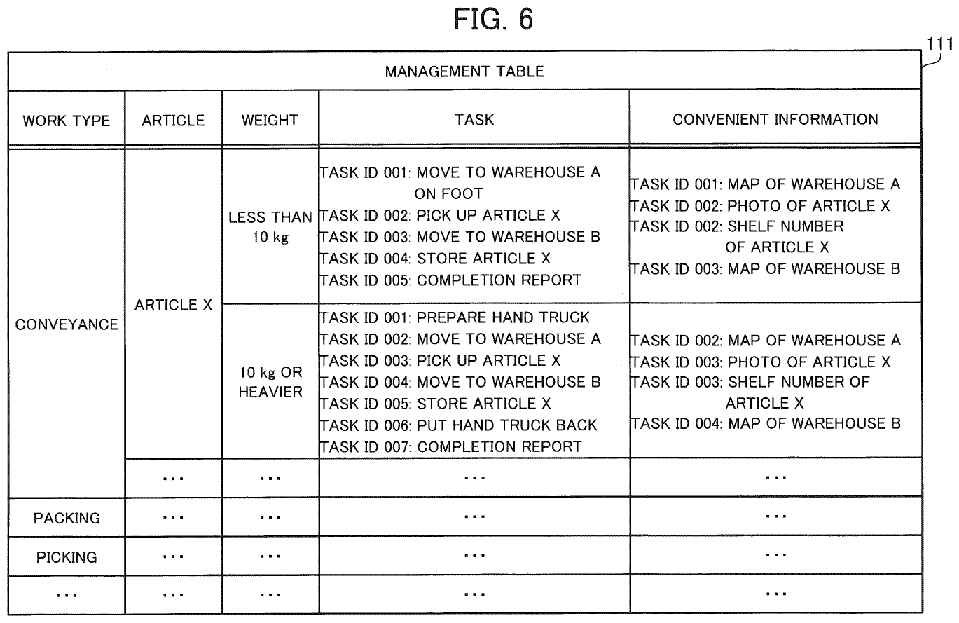

FIG. 6 is a diagram showing an example (No. 1) of the management table in a first modification of the first embodiment. The management table 111 further includes an item of weight.

A case where the management table 111 in FIG. 6 is used will be described below by using a concrete example. The work instruction is assumed to be “Convey an article X weighing 5 kg.” The generation unit 160 generates tasks based on the management table 111, the work type, and one or more words obtained by the morphological analysis. The generation process will be described in detail below. The work type is “conveyance”. The one or more words obtained by the morphological analysis are assumed to be “5 kg” and “article X”. The generation unit 160 identifies tasks corresponding to “conveyance”, “5 kg” and “article X” based on the management table 111. That is, the generation unit 160 identifies tasks in a record of weight “less than 10 kg”. The generation unit 160 generates tasks based on the identified tasks.

Further, the management table 111 can also be a table like the one shown below.

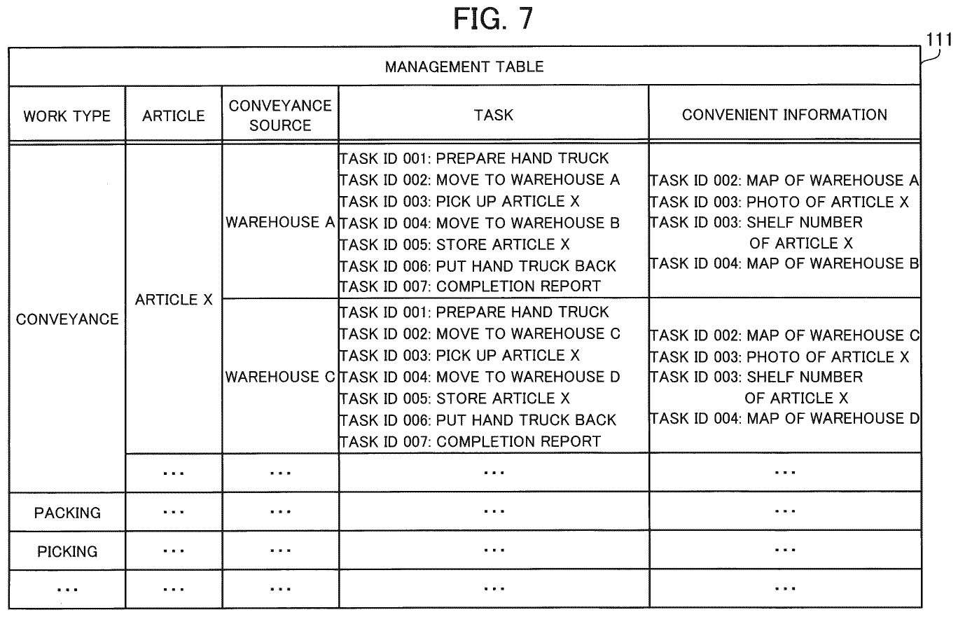

FIG. 7 is a diagram showing an example (No. 2) of the management table in the first modification of the first embodiment. The management table 111 further includes an item of conveyance source.

A case where the management table 111 in FIG. 7 is used will be described below by using a concrete example. The work instruction is assumed to be “Convey an article X existing in warehouse C.” The generation unit 160 generates tasks based on the management table 111, the work type, and one or more words obtained by the morphological analysis. The generation process will be described in detail below. The work type is “conveyance”. The one or more words obtained by the morphological analysis are assumed to be “warehouse C” and “article X”. The generation unit 160 identifies tasks corresponding to “conveyance”, “warehouse C” and “article X” based on the management table 111. That is, the generation unit 160 identifies tasks in a record of conveyance source “warehouse C”. The generation unit 160 generates tasks based on the identified tasks.

In the above-described examples, cases where an item of weight or conveyance source is added to the management table 111 have been shown. Items other than these items may also be added to the management table 111. For example, items of conveyance destination, time slot, date, and so forth are added to the management table 111. As above, the management table 111 may include a variety of items. Then, the generation unit 160 generates tasks based on the management table 111 by using the work type and one or more words obtained by the morphological analysis.

Furthermore, the same purpose as the management table 111 may be realized by using two tables. For example, the two tables are referred to as a work management table and a conveyance management table. Examples of the work management table and the conveyance management table will be shown below.

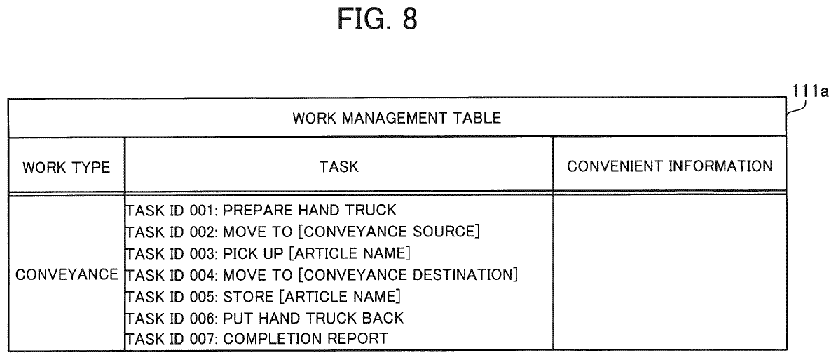

FIG. 8 is a diagram showing an example of the work management table in the first modification of the first embodiment. The work management table 111a includes items of work type, task and convenient information. The parts [CONVEYANCE SOURCE], [CONVEYANCE DESTINATION] and [ARTICLE NAME] shown in FIG. 8 are variable parts.

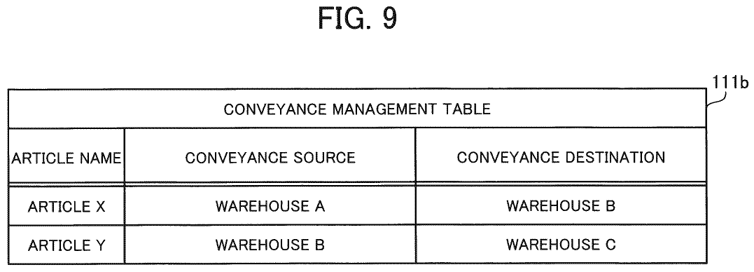

FIG. 9 is a diagram showing an example of the conveyance management table in the first modification of the first embodiment. The conveyance management table 111b includes items of article name, conveyance source and conveyance destination.

A case where the work management table 111a and the conveyance management table 111b are used will be described below. The work instruction is assumed to be “Convey an article X.”. The determination unit 140 determines the work type “conveyance” based on the result of the morphological analysis on the basis of the work instruction information. The acquisition unit 150 acquires tasks corresponding to “conveyance” based on the work management table 111a. The acquisition unit 150 acquires a conveyance source “warehouse A” and a conveyance destination “warehouse B” corresponding to “article X” obtained by the morphological analysis based on the conveyance management table 111b. The generation unit 160 substitutes “article X”, “warehouse A” and “warehouse B” into the variable parts in the acquired tasks.

As above, the same purpose as the management table 111 may be realized by using the work management table 111a and the conveyance management table 111b.

### Second Modification of First Embodiment

In the first embodiment, a case of generating tasks based on the management table 111 has been described. It is also possible for the generation unit 160 to generate tasks based on manual data of the work, the work type, and one or more words obtained by the morphological analysis. The generation process will be described specifically below.

First, the acquisition unit 150 acquires the manual data from the storage unit 110 or the external device. The generation unit 160 searches the manual data for parts describing information necessary for generating tasks by using the work type and one or more words obtained by the morphological analysis. The generation unit 160 generates tasks based on these parts.

As above, the information processing device 100 may generate the tasks by using the manual data.

### Third Modification of First Embodiment

In the first embodiment, a case of generating tasks for one worker has been described. In a third modification, a case of generating tasks for a plurality of workers will be described.

First, an example of the management table 111 will be shown below.

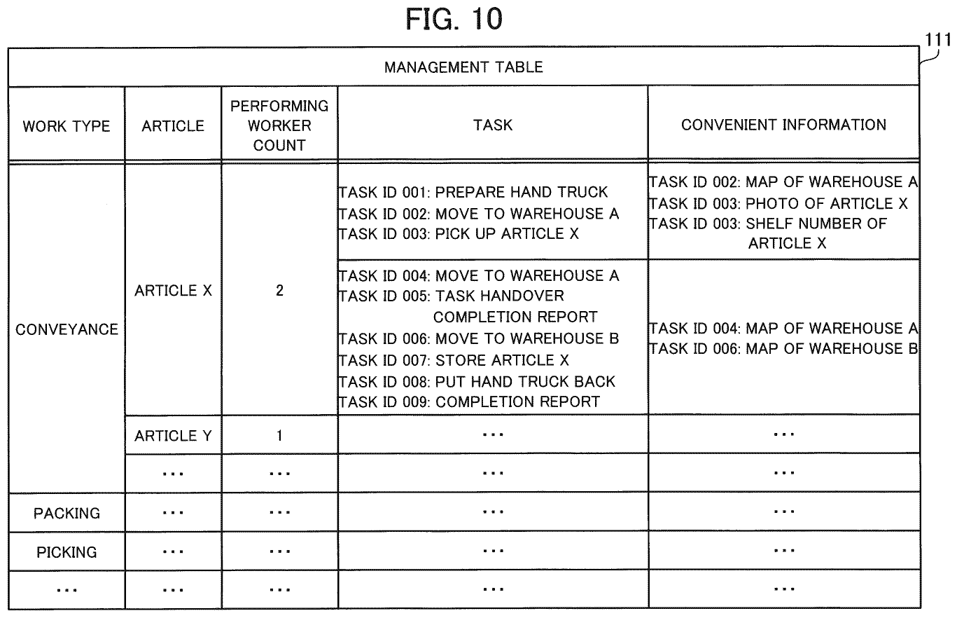

FIG. 10 is a diagram showing an example of the management table in the third modification of the first embodiment. The management table 111 includes an item of performing worker count.

In the third modification of the first embodiment, steps to the step S14 are the same as those in the first embodiment. When the number of workers to perform the tasks corresponding to the work instruction is two or more, the generation unit 160 generates tasks for each of the plurality of workers based on the management table 111, the work type, and one or more words obtained by the morphological analysis. Further, the generation unit 160 generates the convenient information corresponding to each of the tasks based on the management table 111. Here, the acquisition unit 150 may acquire the convenient information from the external device. The communication unit 120 transmits the tasks and the convenient information to each of a plurality of terminal devices used by the plurality of workers. A concrete image diagram will be shown below.

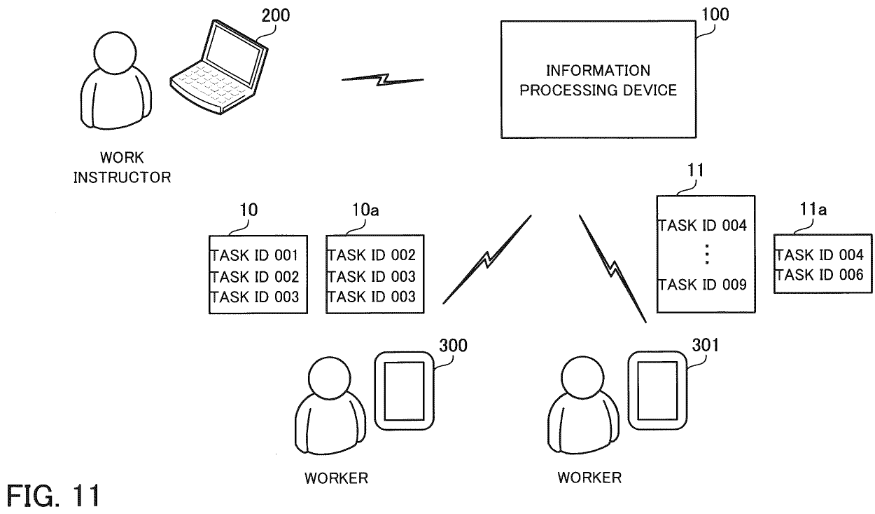

FIG. 11 is an image diagram of a communication system in the third modification of the first embodiment. FIG. 11 indicates two workers. One worker uses the terminal device 300. The other worker uses a terminal device 301.

The information processing device 100 transmits tasks 10 and convenient information 10a to the terminal device 300. The information processing device 100 transmits tasks 11 and convenient information 11a to the terminal device 301. Accordingly, the two workers execute the work corresponding to the work instruction in the work-dividing manner.

According to the third modification of the first embodiment, the information processing device 100 is capable of generating a plurality of tasks and a plurality of pieces of convenient information corresponding to a plurality of workers.

### Second Embodiment

Next, a second embodiment will be described below. In the second embodiment, the description will be given mainly of features different from those in the first embodiment. In the second embodiment, the description is omitted for features in common with the first embodiment.

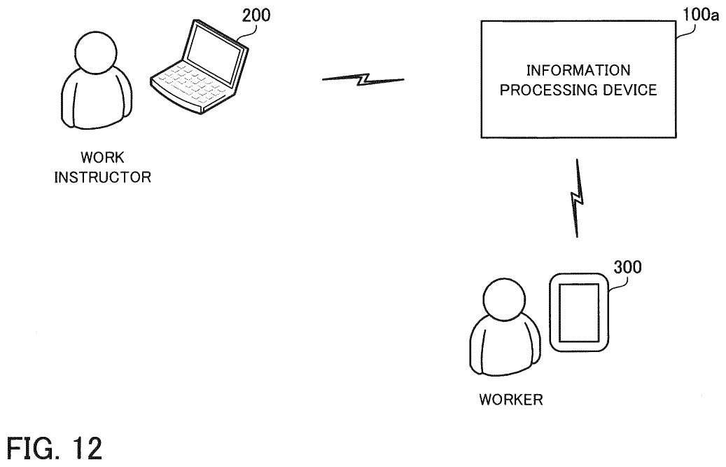

FIG. 12 is a diagram showing a communication system in the second embodiment. The communication system includes an information processing device 100a and the terminal device 300. The communication system may include the information processing device 200.

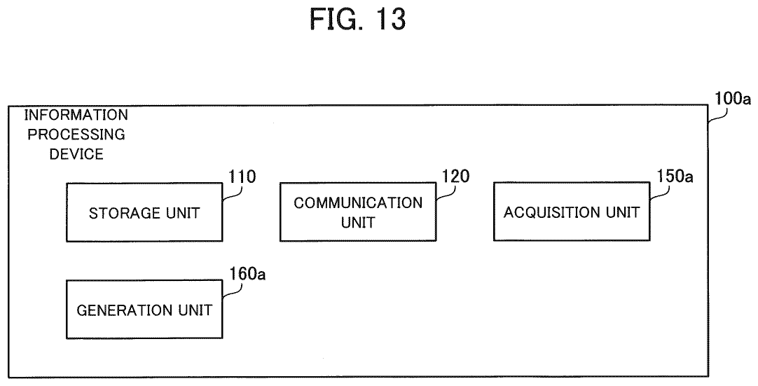

FIG. 13 is a block diagram showing functions of the information processing device in the second embodiment. The information processing device 100a includes an acquisition unit 150a and a generation unit 160a. The information processing device 100a does not include the morphological analysis performing unit 130, the determination unit 140 or the incorporation unit 170.

Part or all of the acquisition unit 150a and the generation unit 160a may be implemented by processing circuitry. Further, part or all of the acquisition unit 150a and the generation unit 160a may be implemented as modules of a program executed by the processor 101.

Functions of the acquisition unit 150a and the generation unit 160a will be described later in detail.

Next, a process executed by the information processing device 100a will be described below by using a flowchart.

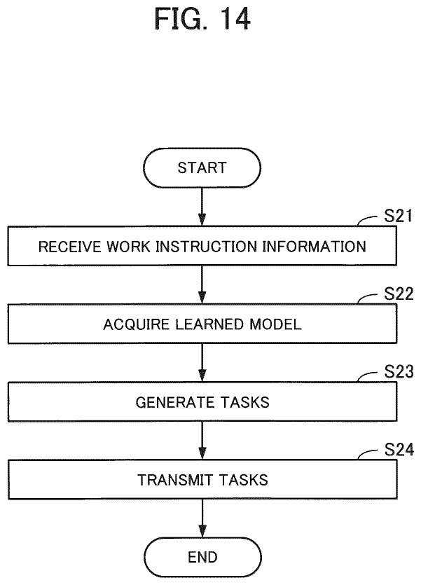

FIG. 14 is a flowchart showing an example of the process executed by the information processing device in the second embodiment.

(Step S21) The communication unit 120 receives the work instruction information from the information processing device 200.

(Step S22) The acquisition unit 150a acquires a learned model from the storage unit 110 or the external device. Incidentally, the learned model has carried out learning so as to generate tasks for the worker to execute the work by supplementing the contents of the work instruction with information.

(Step S23) The generation unit 160a generates tasks corresponding to the work instruction by using the work instruction information and the learned model. Specifically, when the generation unit 160a inputs the work instruction information to the learned model, the learned model outputs the tasks.

(Step S24) The communication unit 120 transmits the tasks to the terminal device 300.

According to the second embodiment, the information processing device 100a generates tasks for implementing the work corresponding to the work instruction. The information processing device 100a transmits the tasks to the terminal device 300. This enables the worker to execute the work without making an inquiry to the work instructor. Accordingly, the information processing device 100a is capable of reducing the load on the work instructor.

In the above embodiments, cases of using the embodiments in logistics or Factory Automation (FA) have been described. The embodiments are applicable also to cases where the work instructor exists in an office and the worker is at home (namely, cases of telework). Further, the embodiments are applicable also to fields of caregiving, construction, and so forth.

### DESCRIPTION OF REFERENCE CHARACTERS

10: task, 10a: convenient information, 11: task, 11a: convenient information, 100: information processing device, 100a: information processing device, 101: processor, 102: volatile storage device, 103: nonvolatile storage device, 110: storage unit, 111: management table, 111a: work management table, 111b: conveyance management table, 120: communication unit, 130: morphological analysis performing unit, 140: determination unit, 150: acquisition unit, 150a: acquisition unit, 160: generation unit, 160a: generation unit, 170: incorporation unit, 200: information processing device, 300: terminal device, 301: terminal device

What is claimed is:

1. An information processing device that communicates with a terminal device used by a worker, comprising:
communicating circuitry to receive work instruction information as information indicating a work instruction to the worker;
morphological analysis performing circuitry to perform morphological analysis on the work instruction information;
determining circuitry to determine a work type based on result of the morphological analysis;
acquiring circuitry to acquire management information as information for generating tasks corresponding to the work instruction or manual data of the work; and
generating circuitry to generate the tasks based on the management information or the manual data, the work type, and one or more words obtained by the morphological analysis,
wherein the communicating circuitry transmits the tasks to the terminal device when the tasks are generated.

2. The information processing device according to claim 1, wherein the communicating circuitry transmits convenient information as information convenient for executing the tasks to the terminal device.

3. The information processing device according to claim 1, further comprising incorporating circuitry, wherein
when a question is received from the terminal device, the communicating circuitry transmits a reply to the question to the terminal device, and
the incorporating circuitry incorporates the reply into the management information.

4. The information processing device according to claim 1, wherein
when a number of people to perform the tasks corresponding to the work instruction is two or more, the generating circuitry generates tasks for each of a plurality of workers based on the management information, the work type, and one or more words obtained by the morphological analysis, and
the communicating circuitry transmits the tasks to each of a plurality of terminal devices used by the plurality of workers.

5. The information processing device according to claim 4, wherein the communicating circuitry transmits convenient information as information convenient for executing the tasks to each of the plurality of terminal devices.

6. An information processing device that communicates with a terminal device used by a worker, comprising:
communicating circuitry to receive work instruction information as information indicating a work instruction to the worker;
acquiring circuitry to acquire a learned model; and
generating circuitry to generate tasks corresponding to the work instruction by using the work instruction information and the learned model,
wherein the communicating circuitry transmits the tasks to the terminal device when the tasks are generated.

7. A communication system comprising:
a terminal device used by a worker; and
an information processing device that communicates with the terminal device,
wherein the information processing device includes:
communicating circuitry to receive work instruction information as information indicating a work instruction to the worker;
morphological analysis performing circuitry to perform morphological analysis on the work instruction information;
determining circuitry to determine a work type based on result of the morphological analysis;
acquiring circuitry to acquire management information as information for generating tasks corresponding to the work instruction or manual data of the work; and
generating circuitry to generate the tasks based on the management information or the manual data, the work type, and one or more words obtained by the morphological analysis,
wherein the communicating circuitry transmits the tasks to the terminal device when the tasks are generated.

8. A communication system comprising:
a terminal device used by a worker; and
an information processing device that communicates with the terminal device,
wherein the information processing device includes:
communicating circuitry to receive work instruction information as information indicating a work instruction to the worker;
acquiring circuitry to acquire a learned model; and
generating circuitry to generate tasks corresponding to the work instruction by using the work instruction information and the learned model,
wherein the communicating circuitry transmits the tasks to the terminal device when the tasks are generated.

9. A control method performed by an information processing device that communicates with a terminal device used by a worker, the control method comprising:
receiving work instruction information as information indicating a work instruction to the worker, performing morphological analysis on the work instruction information, determining a work type based on result of the morphological analysis, acquiring management information as information for generating tasks corresponding to the work instruction or manual data of the work;
generating the tasks based on the management information or the manual data, the work type, and one or more words obtained by the morphological analysis; and
transmitting the tasks to the terminal device.

10. A control method performed by an information processing device that communicates with a terminal device used by a worker, the control method comprising:
receiving work instruction information as information indicating a work instruction to the worker, acquiring a learned model;
generating tasks corresponding to the work instruction by using the work instruction information and the learned model; and
transmitting the tasks to the terminal device.

11. An information processing device that communicates with a terminal device used by a worker, the information processing device comprising:
a processor to execute a program; and
a memory to store the program which, when executed by the processor, performs processes of,
receiving work instruction information as information indicating a work instruction to the worker, performing morphological analysis on the work instruction information, determining a work type based on result of the morphological analysis, acquiring management information as information for generating tasks corresponding to the work instruction or manual data of the work,
generating the tasks based on the management information or the manual data, the work type, and one or more words obtained by the morphological analysis, and
transmitting the tasks to the terminal device.

12. An information processing device that communicates with a terminal device used by a worker, the information processing device comprising:
a processor to execute a program; and
a memory to store the program which, when executed by the processor, performs processes of,
receiving work instruction information as information indicating a work instruction to the worker, acquiring a learned model,
generating tasks corresponding to the work instruction by using the work instruction information and the learned model, and
transmitting the tasks to the terminal device.
